(19) United States
(12) Patent Application Publication
(10) Pub. No.: US 2026/0079236 A1
(43) Pub. Date: Mar. 19, 2026

(54) RADAR SIGNAL PROCESSING METHOD AND RADAR DETECTION DEVICE

(71) Applicant: Wistron Corporation, New Taipei City (TW)

(72) Inventors: Yao-Tsung CHANG, New Taipei City (TW); Yin-Yu CHEN, New Taipei City (TW); Kai-Jen CHENG, New Taipei City (TW); Tsung-Yin TSOU, New Taipei City (TW); Cheng-Nung LIAO, New Taipei City (TW)

(21) Appl. No.: 18/950,556

(22) Filed: Nov. 18, 2024

(30) Foreign Application Priority Data
Sep. 19, 2024 (TW) 113135582

(51) Int. Cl. G01S 7/35; G01S 13/58

(52) U.S. Cl. CPC G01S 7/354; G01S 13/584

(57) ABSTRACT

A radar signal processing method and a radar detection device are provided. The method includes: performing range processing on a plurality of channel signals to obtain a matrix, where the matrix is divided into a first part and a second part according to a separation frequency point; obtaining first information and a corresponding first angle according to the first part; obtaining second information and a corresponding second angle according to the second part; and obtaining a plurality of pieces of information corresponding to a target according to the first information and the second information respectively corresponding to the matched first angle and the matched second angle.

### CROSS-REFERENCE TO RELATED APPLICATION

This non-provisional application claims priority under 35 U.S. C. § 119(a) to Patent Application No. 113135582 filed in Taiwan, R.O.C. on Sep. 19, 2024, the entire contents of which are hereby incorporated by reference.

### BACKGROUND

### Technical Field

The present invention relates to radar technologies, and in particular, to a radar signal processing method and a radar detection device that can distinguish a source of radar measurement information.

### Related Art

Currently, radar technologies can be used to detect physiological information. However, to know a subject from which measurement information comes, the subject can only additionally wear an identity recognition device such as e-tag or RFID. In this way, additional costs of the identity recognition device need to be added, and the additional wearing of the identity recognition device affects convenience and comfort for the subject.

In addition, in a multi-person testing field, physiological information from different users may be distinguished through distance information. However, when the users wear sensors, it is impossible to distinguish the users to which radar measurement information of the sensors belongs through the distance information.

### SUMMARY

An embodiment of the present invention provides a radar signal processing method, performed by a radar detection device. The radar signal processing method includes: obtaining a plurality of channel signals corresponding to a frequency modulated continuous wave radar echo through a radar detection device; performing range processing on each of the channel signals to obtain a distance chirp matrix, where each distance chirp matrix includes at least one first peak element; performing Doppler processing on each distance chirp matrix to obtain a distance rate matrix, where each distance rate matrix includes at least one second peak element; performing first angle processing on each first peak element corresponding to a same position in the distance chirp matrices to obtain a first angle corresponding to each first peak element; performing second angle processing on each second peak element corresponding to a same position in a plurality of distance rate matrices to obtain a second angle corresponding to each second peak element; and obtaining a plurality of pieces of information corresponding to a target according to the first peak element and the second peak element respectively corresponding to the matched first angle and the matched second angle.

An embodiment of the present invention provides a radar signal processing method, performed by a radar detection device. The radar signal processing method includes: obtaining a plurality of channel signals corresponding to a frequency modulated continuous wave radar echo through a radar detection device, where each of the channel signals includes a plurality of digital signals corresponding to a plurality of chirp echoes; separately performing range processing on digital signals of a same ordinal in the plurality of channel signals, to obtain a distance channel matrix; performing angle processing on each distance channel matrix to obtain a range-azimuth matrix, where each range-azimuth matrix includes at least one peak element; obtaining first information according to the at least one peak element in a first part of a plurality of range-azimuth matrices, where each piece of first information corresponds to a first angle of the corresponding peak element; performing Doppler processing on each peak element corresponding to a same position in a second part of the plurality of range-azimuth matrices to obtain second information, where the second information corresponds to a second angle of the corresponding peak element; and classifying the first information and the second information respectively corresponding to the matched first angle and the matched second angle into a group, to obtain a plurality of pieces of information corresponding to a target.

An embodiment of the present invention provides a radar detection device, including: a radar unit, configured to collect and demodulate a frequency modulated continuous wave radar echo to obtain a plurality of channel signals; and a processing unit, configured to: perform range processing on the plurality of channel signals to obtain a matrix, where the matrix is divided into a first part and a second part according to a separation frequency point; obtain first information and a corresponding first angle according to the first part; obtain second information and a corresponding second angle according to the second part; and obtain a plurality of pieces of information corresponding to a target according to the first information and the second information respectively corresponding to the matched first angle and the matched second angle.

According to the radar signal processing method and the radar detection device provided in some embodiments of the present invention, sources of radar measurement information can be distinguished by integrating various information (such as distance information, physiological information, identification code, and sensing information) matching direction angles into a same group. In addition, the foregoing pieces of information can be detected only by using one radar detection device, which saves costs in addition to device space, helps reduce a quantity of devices worn by a user, and is applicable to a testing field in which a plurality of targets exist.

### BRIEF DESCRIPTION OF THE DRAWINGS

FIG. 1 is a block diagram of a radar detection device according to some embodiments of the present invention;

FIG. 2 is a schematic diagram of radar echo signal processing according to some embodiments of the present invention;

FIG. 3 is a flowchart of a radar signal processing method according to some embodiments of the present invention;

FIG. 4 is a schematic diagram of a signal processing process according to some embodiments of the present invention;

FIG. 5 is a detailed flowchart of step S660 in FIG. 3 according to some embodiments of the present invention;

FIG. 6 is a detailed flowchart of step S660 in FIG. 3 according to some embodiments of the present invention;

FIG. 7 is a schematic structural diagram of a delayed reflection sensor according to some embodiments of the present invention;

FIG. 8 is a flowchart of a radar signal processing method according to some embodiments of the present invention;

FIG. 9 is a schematic diagram of a signal processing process according to some embodiments of the present invention; and

FIG. 10 is a flowchart of a radar signal processing method according to some embodiments of the present invention.

### DETAILED DESCRIPTION

To understand the technical features, content, and advantages of the present invention and the effects that can be achieved by the present invention, the following describes in detail expression forms of embodiments with reference to the accompanying drawings. The main purpose of the accompanying drawings used therein is merely schematic and auxiliary to the specification, and is not necessarily a true proportion and precise configuration after the present invention is implemented. Therefore, the scope of the protection scope of the present invention on actual implementation should not be interpreted with reference to the proportion and configuration relationships of the accompanying drawings.

The same reference numerals in all the accompanying drawings are used to represent the same or similar elements. “Including” mentioned herein is an open term, and therefore should be interpreted as “including but not limited to”. As used herein, “coupled” means that two or more elements are in “direct” physical or electrical contact with each other, or are in “indirect” physical or electrical contact with each other. Terms such as “first” and “second” used in this specification are intended to distinguish between the indicated elements, and are not intended to order or limit differences between the indicated elements unless otherwise specified, and are not intended to limit the scope of the present invention.

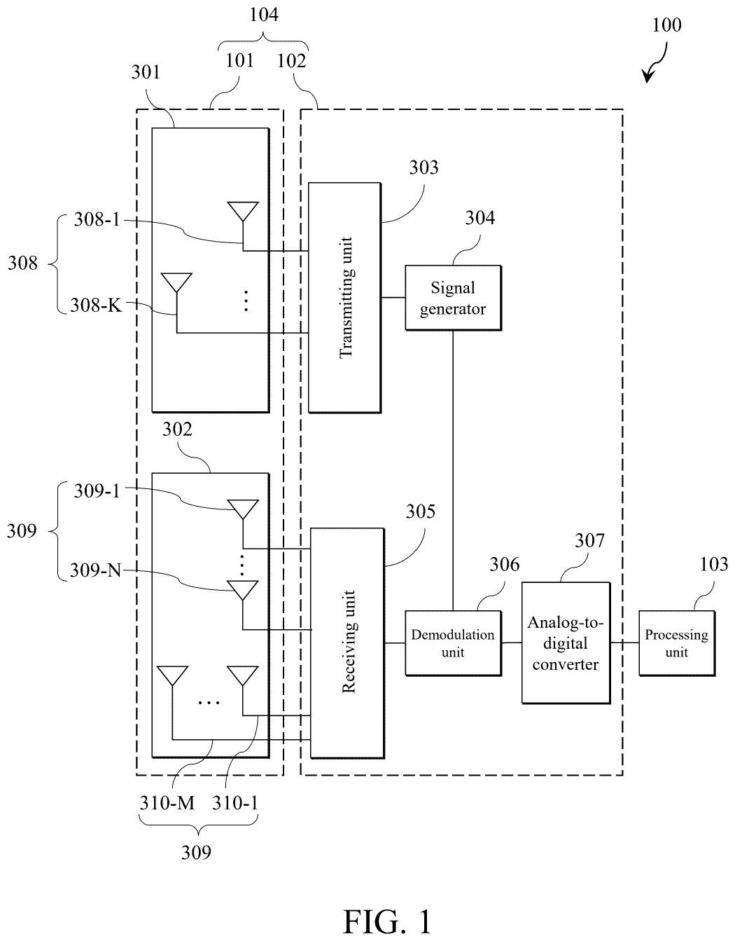

FIG. 1 is a block diagram of a radar detection device 100 according to some embodiments of the present invention. Referring to FIG. 1, the radar detection device 100 includes a radar unit 104 and a processing unit 103 that are coupled to each other. The radar unit 104 includes an antenna unit 101 and a front end unit 102. The antenna unit 101 is configured to radiate a radio frequency signal into a detection field, and a feedback signal is reflected when the radio frequency signal collides with an object in the detection field. The antenna unit 101 receives the feedback signal (that is, a radar echo) of the radio frequency signal. The front end unit 102 is configured to generate the foregoing radio frequency signal, and demodulate and digitize the feedback signal to obtain a digital signal. The processing unit 103 is configured to receive the digital signal and perform signal processing on the digital signal. In some embodiments, the radio frequency signal is a frequency modulated continuous wave (FMCW) signal.

Referring to FIG. 1, the antenna unit 101 further includes a transmitting antenna unit 301 and a receiving antenna unit 302. The transmitting antenna unit 301 includes a plurality of transmitting antennas 308 (308-1 to 308-K are used as an example herein), to radiate the radio frequency signal to the detection field. The receiving antenna unit 302 includes a plurality of receiving antennas 309 (309-1 to 309-N and 310-1 to 310-M are used as examples herein) to receive the feedback signal. K, N, and M are positive integers, and represent configured quantities of transmitting antennas 308-1 to 308-K, receiving antennas 309-1 to 309-N, and receiving antennas 310-1 to 310-M. In some embodiments, the receiving antennas 309-1 to 309-N are arranged along an X axis, and the receiving antennas 310-1 to 310-M are arranged along a Y axis. In some embodiments, the receiving antennas 309 are arranged in a two-dimensional array.

In some embodiments, the transmitting antenna unit 301 and the receiving antenna unit 302 are based on antenna design of single input multiple output (SIMO), multiple input multiple output (MIMO), or multiple input single output (MISO). The antenna may be a patch antenna or the like, for example, a dual-dipole patch antenna.

As shown in FIG. 1, the front end unit 102 includes a signal generator 304, a transmitting unit 303, a receiving unit 305, a demodulation unit 306, and an analog-to-digital converter 307. The signal generator 304 generates the radio frequency signal and simultaneously transmits the radio frequency signal to the transmitting unit 303 and the demodulation unit 306. The transmitting unit 303 includes a power amplifier (PA), configured to amplify the radio frequency signal and transmit an amplified radio frequency signal to the transmitting antenna unit 301 to radiate the radio frequency signal to the detection field.

The receiving unit 305 includes a signal amplifier and a filter (not shown), configured to receive the feedback signal received by the antenna unit 101, and amplify and filter the received feedback signal. The demodulation unit 306 is coupled to the signal generator 304 and the receiving unit 305. The demodulation unit 306 receives the radio frequency signal generated by the signal generator 304 and the feedback signal amplified and filtered by the receiving unit 305, demodulates an amplified and filtered feedback signal based on the radio frequency signal, performs frequency mixing and combination, and filters out a high frequency signal, to generate an intermediate frequency (IF) signal. The analog-to-digital converter 307 converts the intermediate frequency signal into the digital signal. The digital signal is transmitted to the processing unit 103 for subsequent signal processing to obtain information included in the feedback signal.

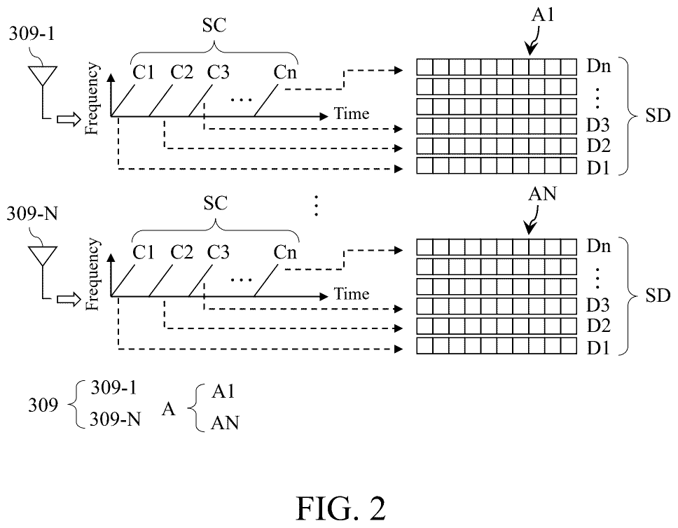

Referring to FIG. 2, FIG. 2 is a schematic diagram of processing a radar echo signal according to some embodiments of the present invention. FIG. 2 shows that feedback signals received by a plurality of receiving antennas 309 (309-1 to 309-N are used as an example herein) in one axial direction are demodulated and converted into digital signals SD. The feedback signal includes a plurality of chirp echoes SC (C1 to Cn herein, n being a positive integer) in each frame. A frequency of the chirp echo SC increases linearly with time. After being demodulated by the demodulation unit 306, each of the chirp echoes C1 to Cn is converted into the digital signal SD (D1 to Dn herein, n being a positive integer) by the analog-to-digital converter 307. In other words, the chirp echo C1 is transmitted, reflected, received, demodulated, and converted from analog to digital to form the digital signal D1; the chirp echo C2 is transmitted, reflected, received, demodulated, and converted from analog to digital to form the digital signal D2; and the like. Values of the digital signals D1 to Dn may be represented as a one-dimensional array (row). The digital signals D1 to Dn obtained according to feedback signals received by a same receiving antenna 309 (309-1 to 309-N) are sequentially arranged longitudinally to form a data matrix A (A1 to AN, N being a positive integer). For example, the data matrix A1 is formed by the digital signals D1 to Dn corresponding to the receiving antenna 309-1. A longitudinal axis of the data matrix A corresponds to indexes (ordinals) of the chirp echoes C1 to Cn. Therefore, the longitudinal axis of the data matrix A covers cycle time of all the chirp echoes C1 to Cn, and may express information of slow time. A transverse axis of the data matrix A corresponds to cycle time of one of the chirp echoes C1 to Cn, and may express information of fast time. A value of each element in the data matrix A represents signal strength (amplitude).

A channel is correspondingly between any transmitting antenna 308 and any receiving antenna 309. The “channel signal” in the specification refers to a digital signal SD obtained by performing the foregoing processing such as demodulation and analog-to-digital conversion on a frequency modulated continuous wave signal that is transmitted by a transmitting antenna 308 and received by a receiving antenna 309. A plurality of channel signals refer to digital signals SD obtained by different combinations of the transmitting antennas 308 and the receiving antennas 309. For ease of description, antenna design of SIMO is used for description in the specification. Therefore, digital signals SD (that is, different data matrices A) corresponding to different receiving antennas 309 refer to different channel signals (as shown in FIG. 2).

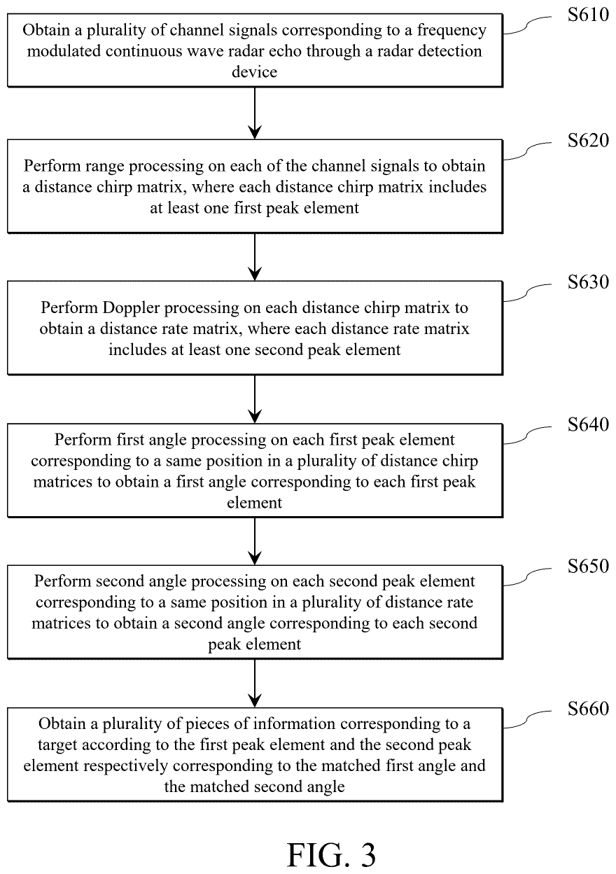

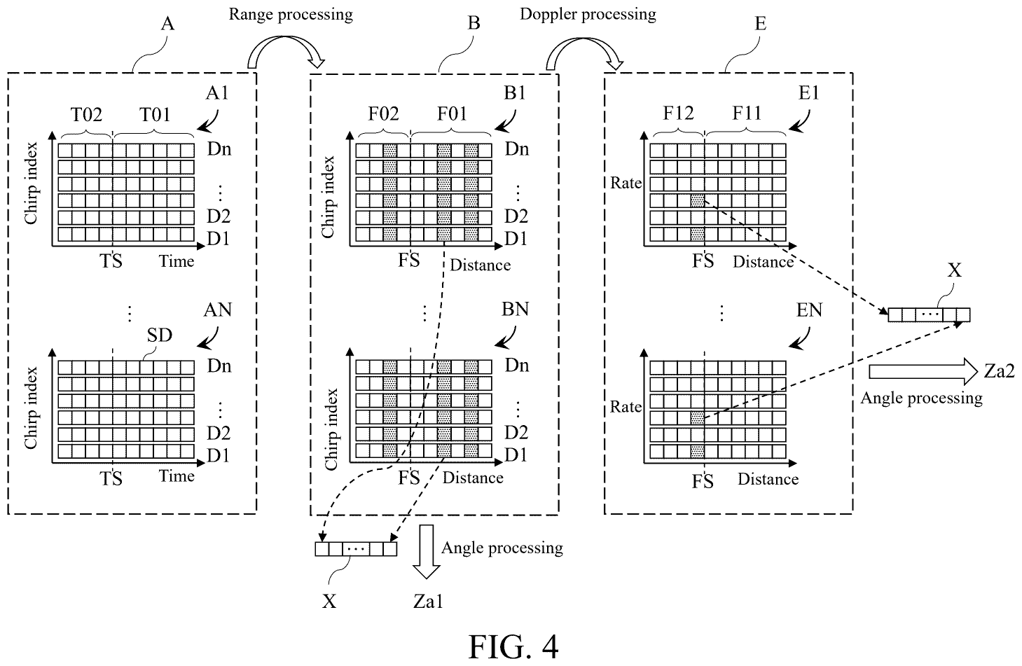

Refer to FIG. 3 and FIG. 4 together. FIG. 3 is a flowchart of a radar signal processing method according to some embodiments of the present invention. FIG. 4 is a schematic diagram of a signal processing process according to some embodiments of the present invention. Step S610: Obtain a plurality of channel signals corresponding to a frequency modulated continuous wave radar echo through a radar detection device 100. As shown in FIG. 4, each channel signal is represented as a data matrix A (as shown in FIG. 2).

Step S620: Perform range processing on each channel signal (the data matrix A, that is, A1 to AN) to obtain a distance chirp matrix B (B1 to BN). A transverse axis of the distance chirp matrix B is a distance, and a longitudinal axis of the distance chirp matrix B is a chirp echo SC index. Range processing includes range fast Fourier transform (Range FFT), which is to first perform fast Fourier transform processing on the data matrix A in a fast time direction, that is, fast Fourier transform processing is performed on each digital signal SD. Since the frequency of the chirp echo SC linearly increases with time (a linear frequency modulation slope), frequency domain distribution generated after the digital signal SD is subject to fast Fourier transform processing is in a linear relation with transmission time of the chirp echo SC. The transmission time of the chirp echo SC may be converted into a distance through an electromagnetic wave transmission speed. Therefore, after the digital signal SD is converted into frequency domain distribution through a frequency domain, the digital signal SD may be further converted into distance distribution, which is referred to as range fast Fourier transform. Each peak element (for example, a color filling region) after being subject to range fast Fourier transform processing represents that an object is at a corresponding distance. A peak element included in the distance chirp matrix B is referred to as a first peak element below.

Step S630: Perform Doppler processing on each distance chirp matrix B (B1 to BN) to obtain a distance rate matrix E (E1 to EN). A transverse axis of the distance rate matrix E is a distance, and a longitudinal axis of the distance rate matrix E is a rate. Doppler processing includes Doppler fast Fourier transform (Doppler FFT), which is to first perform fast Fourier transform processing on the distance chirp matrix B in a slow time direction (a longitudinal axis), to represent frequency distribution (a frequency offset) of a phase change. The frequency offset is directly proportional to a relative speed of an object, and may be converted into a rate. This is referred to as Doppler fast Fourier transform. Each peak element (for example, a color filling region) after being subject to Doppler fast Fourier transform processing represents that an object moving or having periodically changing motion is at a corresponding distance. A peak element included in the distance rate matrix E is referred to as a second peak element below.

Step S640: Perform angle processing (or referred to as first angle processing) on each first peak element corresponding to a same position (that is, a same distance and a same chirp index) in the distance chirp matrix B (B1 to BN) to obtain an angle (referred to as a first angle Za1 herein) corresponding to each first peak element. Angle processing includes angle fast Fourier transform (Angle FFT). In an embodiment, estimation is performed through an angle of arrival (AoA). Estimation of the angle of arrival is based on a phasor change of a range fast Fourier transform or Doppler fast Fourier transform peak, which requires at least two transmitting antennas or at least two receiving antennas. Since distances between an object and antennas are different, a direction of the object can be detected by using a phase difference between two antennas. The first peak elements corresponding to the same position in the distance chirp matrix B (B1 to BN) are selected to form a one-dimensional array X. Elements of the array X are in one-to-one correspondence with the receiving antennas 309 (309-1 to 309-N). Fast Fourier transform, that is, angle fast Fourier transform is performed on a phasor sequence of the array X, and the first angle Za1 corresponding to the first peak element may be calculated. In some embodiments, step S640 is between step S620 and step S660, and a sequence of performing the steps is not limited to that in FIG. 3.

Similarly, in step S650, another angle processing (or referred to second angle processing) is performed on each second peak element corresponding to a same position in the distance rate matrix E (E1 to EN) to obtain an angle (referred to as a second angle Za2 herein) corresponding to each second peak element. In some embodiments, step S650 is between step S630 and step S660, and a sequence of performing the steps is not limited to that in FIG. 3.

Step S660: Obtain a plurality of pieces of information corresponding to a target according to the first peak element and the second peak element respectively corresponding to the matched first angle Za1 and the matched second angle Za2. The “matched” means that a difference between the first angle Za1 and the second angle Za2 is within an allowable range. The allowable range may be determined according to the volume of the detected target. By finding the first peak element with the matched first angle Za1 and the second peak element with the matched second angle Za2, it can be determined that the first peak element and the second peak element are from the same target.

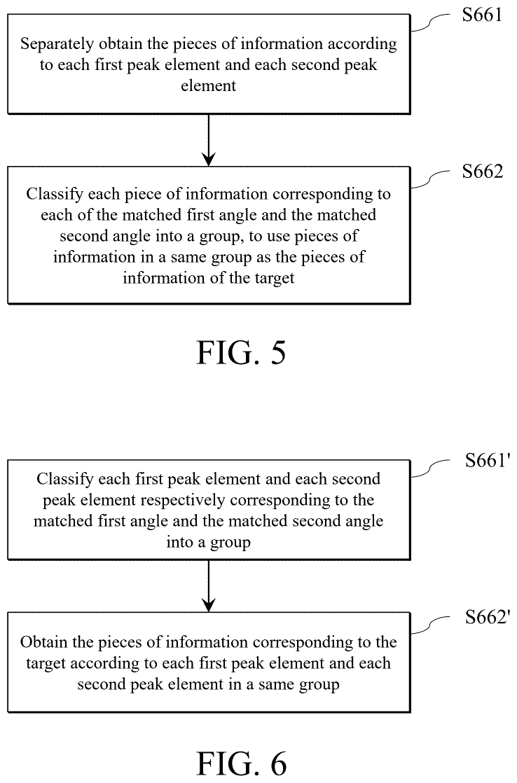

Referring to FIG. 5, FIG. 5 is a detailed flowchart of step S660 in FIG. 3 according to some embodiments of the present invention. In some embodiments, respective information is first separately obtained according to the first peak element and the second peak element (step S661), and then the information respectively corresponding to the matched first angle Za1 and the matched second angle Za2 is classified into a group, to use the information in a same group as information of a same target (step S662).

Referring to FIG. 6, FIG. 6 is a detailed flowchart of step S660 in FIG. 3 according to some embodiments of the present invention. In some embodiments, each first peak element and each second peak element respectively corresponding to the matched first angle Za1 and the matched second angle Za2 are classified into a group (step S661′), and then information of a same target is obtained according to the first peak elements and the second peak elements in a same group (step S662′).

In some embodiments, the target is an organism wearing a delayed reflection sensor 200 (described in detail below). The information of the same target includes: first information (for example, an identification code or sensing information) corresponding to the delayed reflection sensor 200 and second information (for example, a distance or physiological information such as a breathing frequency or a heartbeat frequency) corresponding to the organism.

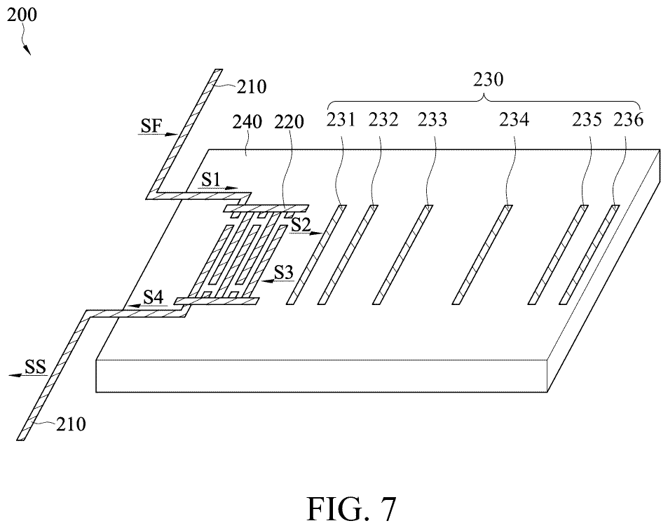

Referring to FIG. 7, FIG. 7 is a schematic structural diagram of a delayed reflection sensor 200 according to some embodiments of the present invention. The delayed reflection sensor 200 can receive a radio frequency signal SF and then reflect a feedback signal SS after a period of time. The delayed reflection sensor 200 is a passive surface acoustic wave (SAW) sensor. The delayed reflection sensor 200 includes an antenna 210, a transducer 220, a plurality of reflectors 230 (231 to 236 are used as an example herein), and a piezoelectric substrate 240. In some embodiments, the transducer 220 is an interdigital transducer (IDT). The antenna 210, the transducer 220, and the reflector 230 are made of metal materials. The piezoelectric substrate 240 is a substrate made of a piezoelectric material.

Specifically, when receiving the radio frequency signal SF, the antenna 210 generates a first electrical signal S1 according to the radio frequency signal SF. The transducer 220 is coupled to the antenna 210, and is arranged on the piezoelectric substrate 240. Through a reverse piezoelectric effect of the piezoelectric substrate 240, the transducer 220 converts the first electrical signal S1 into a first surface acoustic wave signal S2 that is transmitted toward the reflector 230. Then, when the first surface acoustic wave signal S2 hits the first reflector 231, through a piezoelectric effect of the piezoelectric substrate 240, a second surface acoustic wave signal S3 is generated, and the second surface acoustic wave signal S3 is transmitted to the transducer 220. This action is referred to as “acoustic wave reflection” for short. Through the piezoelectric effect of the piezoelectric substrate 240, the transducer 220 then converts the second surface acoustic wave signal S3 into a second electrical signal S4. Finally, the antenna 210 transmits the feedback signal SS to the radar detection device 100 according to the second electrical signal S4. It should be noted that a part of energy of the first surface acoustic wave signal S2 is reflected by the first reflector 231, and the remaining energy continues to be transmitted to the second reflector 232. After the second reflector 232 reflects a part of the remaining energy, the remaining energy continues to be transmitted to the third reflector 232, and so on. The first surface acoustic wave signal S2 is sequentially acoustically reflected by the plurality of reflectors 230, a plurality of second surface acoustic wave signals S3 are correspondingly sequentially generated, and finally a plurality of corresponding feedback signals SS are returned to the radar detection device 100. Since a position of the reflector 230 determines a path length for acoustic wave transmission (that is, determines delay time), a combination of feedback signals SS with specific delayed reflection time may be generated according to the position at which each reflector 230 is arranged on the piezoelectric substrate 240. In some embodiments, a combination of delayed reflection time may correspond to one identification code. The identification code may be configured to identify an identity of an organism wearing the delayed reflection sensor 200.

In some embodiments, since an environmental factor affects a surface acoustic wave transmission speed, a material of the piezoelectric substrate 240 may be selected, and a material characteristic of the piezoelectric substrate 240 causes the surface acoustic wave transmission speed to change in a positive correlation (or a negative correlation) when an environmental factor changes. A linear or non-linear regression model or another machine learning model may be constructed through experimental data to display the positive correlation (or negative correlation). Therefore, according to the constructed model, a measurement value of the environmental factor may be estimated by using the delayed reflection time. In this way, the delayed reflection sensor 200 may be used as a sensor of a specific environmental factor (temperature, humidity, pressure, or a chemical ingredient).

In some embodiments, a reflector 230 (for example, the first reflector 231) may be used as a reference to calculate time differences between the remaining reflectors 230 and the reference reflector 230. In addition, delayed reflection time of some reflectors 230 may alternatively be used to normalize delayed reflection time of other reflectors 230. FIG. 7 is used as an example. A time difference between delayed reflection time of two outermost reflectors 231 and 236 may be used as a normalization factor, and a time difference between delayed reflection time of the remaining reflectors 232 to 235 and the delayed reflection time of the reflector 231 may be divided by the normalization factor. Through a combination of normalized delayed reflection time, an impact of the foregoing environmental factor can be avoided, to identify a corresponding identification code. In addition, the two reflectors 231 and 236 used as the normalization factor are designed at a fixed spacing, so that an environmental factor change can be estimated through a change of the delayed reflection time of the two reflectors 231 and 236. In this way, the delayed reflection sensor 200 can have functions of both an identification code and a sensor.

Still refer to FIG. 4. Since an acoustic wave transmission speed is significantly lower than an electromagnetic wave transmission speed, whether a source of the feedback signal is the delayed reflection sensor 200 can be distinguished through the delay time. Corresponding to a sound speed, delay time of the delayed reflection sensor 200 is usually in a microsecond level. Relatively speaking, delay time of a radar echo of a common object is only in a 10-nanosecond level. Therefore, the data matrix A may be divided into two parts through an appropriate separation time point TS. A first part T01 is a part higher than the separation time point TS, and a second part T02 is a part lower than the separation time point TS. Therefore, information of the delayed reflection sensor 200 appears only at the first part T01 but does not appear at the second part T02. In some embodiments, the separation time point TS is selected from a range of 100 nanoseconds to 1 microsecond.

Since the frequency of the chirp echo SC is in a linear relation with the time (linear frequency modulation), the separation time point TS may be converted into a corresponding separation frequency point FS according to the linear frequency modulation slope. As described in the foregoing range fast Fourier transform, the separation frequency point FS may be converted into a distance according to the linear frequency modulation slope and the electromagnetic wave transmission speed, to meet a measurement standard of transverse axes of the distance chirp matrix B and the distance rate matrix E.

Specifically, the separation frequency point FS divides the distance chirp matrix B into two parts. A first part F01 is a part higher than the separation frequency point FS, and a second part F02 is a part lower than the separation frequency point FS. Therefore, the information of the delayed reflection sensor 200 appears only at the first part F01 but does not appear at the second part F02. In addition, the separation frequency point FS divides the distance rate matrix E into two parts. A first part F11 is a part higher than the separation frequency point FS, and a second part F12 is a part lower than the separation frequency point FS. Therefore, information of the organism appears only at the second part F12 but does not appear at the first part F11.

In some embodiments, in step S660, the delay time caused by each reflector 230 of the delayed reflection sensor 200 may be found according to the first part F01 of the distance chirp matrix B, and the identification code is obtained according to the delay time. Specifically, a distance of each first peak element in the same group (representing being from the same delayed reflection sensor 200) in the first part F01 is first converted into delay time according to the linear frequency modulation slope of the frequency modulated continuous wave radar echo. Then, an identification code of the corresponding delayed reflection sensor 200 is calculated according to the delay time corresponding to the same group (such as the foregoing normalization manner). The foregoing first information corresponding to the delayed reflection sensor 200 includes the identification code.

In some embodiments, in step S660, the delay time caused by each reflector 230 of the delayed reflection sensor 200 may be found according to the first part F01 of the distance chirp matrix B, and the sensing information is obtained according to the delay time. Specifically, after the distance of each first peak element in the same group in the first part F01 is converted into the delay time, the sensing information of the corresponding delayed reflection sensor 200 may be calculated according to the delay time corresponding to the same group (for example, the foregoing delayed reflection time corresponding to the two outermost reflectors 231 and 236). The first information corresponding to the delayed reflection sensor 200 includes the sensing information.

In some embodiments, the organism and the delayed reflection sensor 200 worn by the organism are at a same angle, and therefore are classified into a same group. Step S660: Obtain distance information of the target (which represents both the organism and the delayed reflection sensor 200) according to a distance of each first peak element in a same group in a second part F02 of the distance chirp matrix B. The second information corresponding to the organism includes the distance information.

In some embodiments, in step S660, a rate change caused by the organism may be found according to the second part F12 of the distance rate matrix E, and the physiological information is obtained according to the rate change. Specifically, at least one piece of physiological information (such as a breathing frequency or a heartbeat frequency) of the corresponding organism is calculated according to the rate of each second peak element in the same group (representing being from the same organism) in the second part F12. The second information corresponding to the organism includes the physiological information.

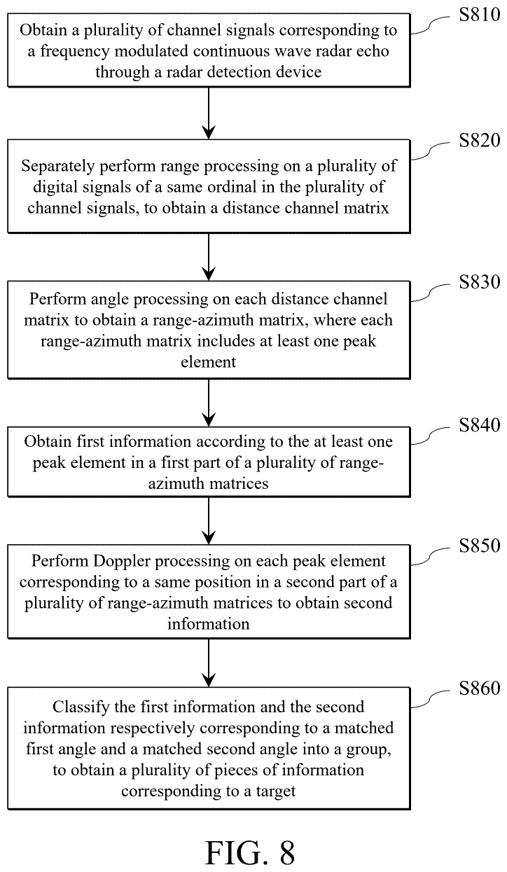

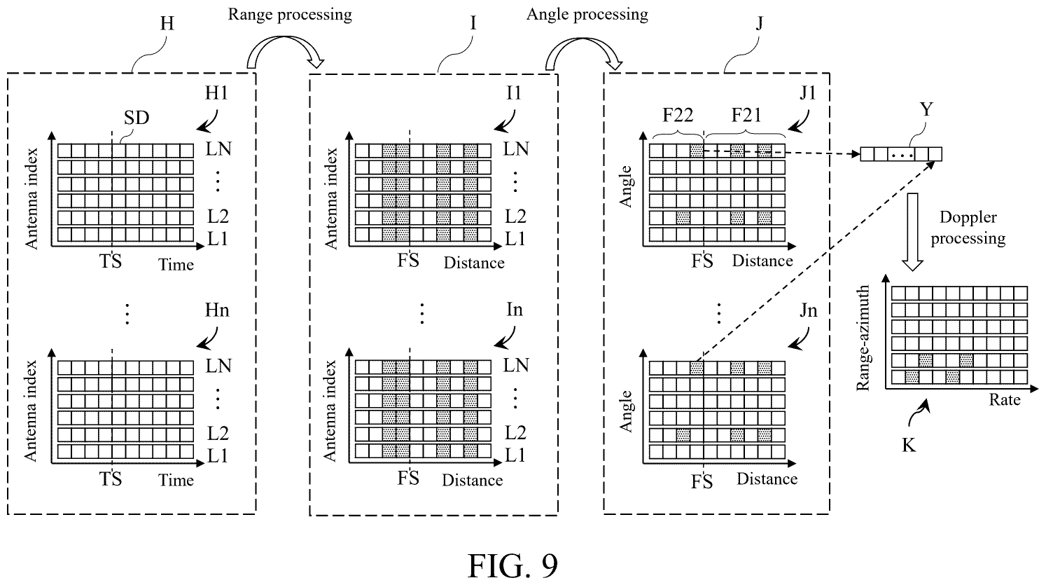

Referring to FIG. 8 and FIG. 9 together, another signal processing procedure is described. FIG. 8 is a flowchart of a radar signal processing method according to some embodiments of the present invention. FIG. 9 is a schematic diagram of a signal processing process according to some embodiments of the present invention. Step S810: Obtain a plurality of channel signals corresponding to a frequency modulated continuous wave radar echo through a radar detection device 100. Each channel signal corresponds to different receiving antennas L1 to LN (N is a positive integer), and includes a plurality of digital signals SD respectively corresponding to chirp echoes C1 to Cn. As shown in FIG. 9, digital signals SD corresponding to a same chirp echo SC in the channel signals are represented by rows, and are arranged longitudinally in an index sequence of the corresponding receiving antennas L1 to LN, to form a data matrix H (H1 to Hn, n being a positive integer). To be specific, the data matrix Hn is formed by digital signals SD of corresponding nth chirp echoes Cn in all the channel signals. A longitudinal axis of the data matrix H corresponds to indexes (ordinals) of the receiving antennas L1 to LN. A transverse axis of the data matrix H corresponds to cycle time of one of the chirp echoes C1 to Cn. A value of each element in the data matrix H represents signal strength (amplitude).

Step S820: Separately perform range processing on the digital signals of a same ordinal in the channel signals. In other words, range processing is performed on the data matrices H1 to Hn separately. Each data matrix H includes digital signals SD corresponding to a same ordinal of the chirp echoes C1 to Cn in all the channel signals (referring to the receiving antennas L1 to LN herein). Range processing includes range fast Fourier transform, which is to first perform fast Fourier transform processing on the data matrix H in a fast time direction (that is, on the digital signals SD), and then convert frequency domain distribution into distance distribution. Each peak element (for example, a color filling region) after being subject to range fast Fourier transform processing represents that an object is at a corresponding distance. After range processing, a distance channel matrix I (I1 to In) is obtained. A transverse axis of the distance channel matrix I is a distance, and a longitudinal axis of the distance channel matrix I is the indexes of the receiving antennas L1 to LN.

Step S830: Perform angle processing on each distance channel matrix I (I1 to In), to obtain a range-azimuth matrix J (J1 to Jn). Angle processing includes angle fast Fourier transform, whose content is described above, and is not described herein again. Angle fast Fourier transform processing is performed along the longitudinal axis of the distance channel matrix I. A transverse axis of the range-azimuth matrix J is a distance, and a longitudinal axis of the range-azimuth matrix J is an angle. Each peak element (for example, a color filling region) after being subject to angle fast Fourier transform processing corresponds to a distance and an angle, which represent a position of the object.

As described above, the range-azimuth matrix J may also be divided into two parts by the separation frequency point FS. A first part F21 is a part higher than the separation frequency point FS, and a second part F22 is a part lower than the separation frequency point FS. For ease of description, an angle of each peak element in the first part F21 is referred to as a first angle, and an angle of each peak element in the second part F22 is referred to as a second angle.

Step S840: Obtain first information according to a peak element in a first part F21 of the range-azimuth matrix J. Therefore, the obtained first information corresponds to the first angle of the corresponding peak element. In some embodiments, the first information includes information related to the delayed reflection sensor 200, for example, an identification code and sensing information.

Step S850: Perform Doppler processing according to each peak element corresponding to a same position in a second part F22 of the range-azimuth matrix J to obtain second information. Specifically, the peak elements corresponding to the same position in the range-azimuth matrix J (J1 to Jn) are selected to form a one-dimensional array Y. Elements of the array Y are in one-to-one correspondence with the ordinals of the chirp echoes C1 to Cn. Doppler processing includes Doppler fast Fourier transform, whose content is described above, and is not described herein again. By performing Doppler fast Fourier transform on the array Y, a rate of a corresponding peak element may be calculated, and corresponding information (referred to as second information herein) may be obtained according to the rate. The obtained second information corresponds to the second angle of the corresponding peak element. The second information includes information related to the organism, for example, physiological information (for example, a breathing frequency or a heartbeat frequency). As shown in FIG. 9, a range-azimuth rate matrix K may be drawn according to a rate, a distance, and a second angle of a peak element. The color filling region represents that an object moving or having periodically changing motion is at a corresponding range-azimuth. In some embodiments, step S840 and step S850 may be performed interchangeably.

Step S860: Classify the first information and the second information respectively corresponding to the matched first angle and the matched second angle into a group, to obtain a plurality of pieces of information corresponding to a target. In some embodiments, the target is an organism wearing the delayed reflection sensor 200. The information corresponding to the target includes the first information corresponding to the delayed reflection sensor 200 and the second information corresponding to the organism.

In some embodiments, in step S840, the distance of each peak element in the first part F21 of the range-azimuth matrix J is first converted into delay time according to a linear frequency modulation slope of the frequency modulated continuous wave radar echo. Then, an identification code of the corresponding delayed reflection sensor 200 is calculated according to each delay time (representing being from the same delayed reflection sensor 200) corresponding to the same group (such as the foregoing normalization manner).

In some embodiments, in step S840, after the distance of each peak element in the first part F21 of the range-azimuth matrix J is converted into the delay time, the sensing information of the corresponding delayed reflection sensor 200 may be calculated according to the delay time corresponding to the same group (for example, the foregoing delayed reflection time corresponding to the two outermost reflectors 231 and 236).

In some embodiments, the distance information of the target may be further obtained according to the distance of each peak element in the same group in the second part F22 of the range-azimuth matrix J.

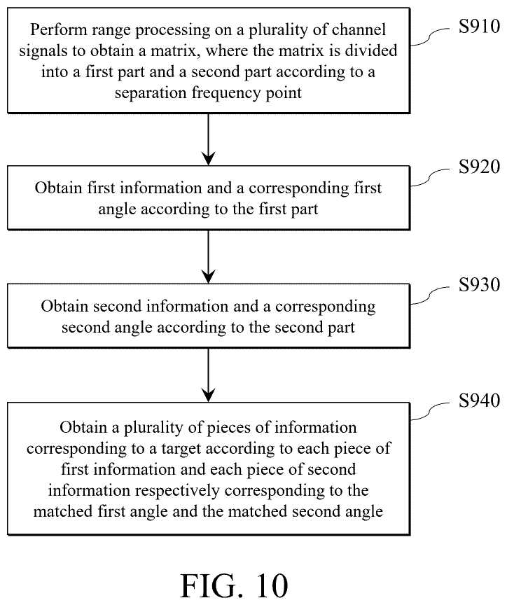

Referring to FIG. 10, FIG. 10 is a flowchart of a radar signal processing method according to some embodiments of the present invention. Step S910: Perform range processing on a plurality of channel signals to obtain a matrix (such as a distance chirp matrix B in FIG. 4 and a distance channel matrix I in FIG. 9). A plurality of matrices may be divided into a first part higher than the separation frequency point FS and a second part lower than the separation frequency point FS according to the separation frequency point FS.

Step S920: Obtain first information and a corresponding first angle according to a first part. Specifically, the first information (such as an identification code and sensing information) related to the delayed reflection sensor 200 may be calculated according to a distance of a peak unit of the first part. In addition, through angle processing, an angle (the first angle) of the corresponding peak unit may be obtained.

Step S930: Obtain second information and a corresponding second angle according to a second part. Specifically, a distance related to the organism may be calculated according to a distance of a peak unit of the second part. A rate of the corresponding peak unit may be obtained through Doppler processing, and physiological information of the organism is calculated according to the rate. The calculated distance and the physiological information are the second information related to the organism. In addition, through angle processing, an angle (the second angle) of the corresponding peak unit may be obtained. In some embodiments, step S920 and step S930 may be performed interchangeably.

In step S940, each piece of corresponding first information and each piece of corresponding second information may be classified into a group according to the matched first angle and the matched second angle, to obtain a plurality of pieces of information corresponding to a target (the organism wearing the delayed reflection sensor 200).

In some embodiments, the processing unit 103 includes one or more processing modules. In some embodiments, a part of the processing unit 103 is located in the radar unit 104. For example, the processing unit 103 includes a first processing module and a second processing module. The first processing module is located in the radar unit 104, and is configured to perform a part of signal processing and transmit a processing result to the second processing module, and the second processing module successively performs remaining signal processing.

In some embodiments, the processing module includes a processor, an internal memory, and a non-volatile memory. The internal memory is, for example, a random access memory (RAM). Definitely, the processing module may further include hardware required for other functions.

The internal memory and the non-volatile memory are configured to store a program. The program may include program code, and the program code includes computer operation instructions. The internal memory and the non-volatile memory provide instructions and data to the processor. The processor reads a corresponding computer program from the non-volatile memory into the internal memory and then runs the computer program. The processor is specifically configured to perform the steps in the foregoing flowcharts.

The processor may be an integrated circuit chip, and has a signal processing capability. In an implementation process, the methods and steps disclosed in the foregoing embodiments may be implemented by using a hard integrated logic circuit or an instruction in a software form in the processor. The processor may be a general-purpose processor, including a central processing unit (CPU), a tensor processing unit, a digital signal processor (DSP), an application specific integrated circuit (ASIC), a field-programmable gate array (FPGA), or another programmable logic apparatus, and may implement or perform the methods and steps disclosed in the foregoing embodiments.

In some embodiments of the present invention, a computer-readable recording medium in which a program is stored is further provided. The computer-readable recording medium stores at least one instruction. The at least one instruction, when executed by the processing unit 103, causes the processing unit 103 to perform the methods and steps disclosed in the foregoing embodiments.

The computer-readable recording medium includes, but is not limited to, a phase change memory (PRAM), a static random access memory (SRAM), a dynamic random access memory (DRAM), another type of random access memory (RAM), a read-only memory (ROM), an electrically erasable programmable read-only memory (EEPROM), a flash memory or another internal memory technology, a read-only compact disc read-only memory (CD-ROM), a digital versatile disc (DVD) or another optical memory, a magnetic cassette tape, a tape-type magnetic disk memory or another magnetic storage device, or any other non-transmission medium, which may be configured to store information accessible by a computing device. As defined in this specification, the computer-readable medium does not include a transient medium, such as a modulated data signal and a carrier wave.

According to the radar signal processing method and the radar detection device 100 provided in some embodiments of the present invention, sources of radar measurement information can be distinguished by integrating various information (such as distance information, physiological information, identification code, and sensing information) matching direction angles into a same group. In addition, the foregoing pieces of information can be detected only by using one radar detection device 100, which saves costs in addition to device space, helps reduce a quantity of devices worn by a user, and is applicable to a testing field in which a plurality of targets exist.

What is claimed is:

1. A radar signal processing method, performed by a radar detection device, the radar signal processing method comprising:
obtaining a plurality of channel signals corresponding to a frequency modulated continuous wave radar echo through the radar detection device;
performing range processing on each of the channel signals to obtain a distance chirp matrix, wherein each distance chirp matrix comprises at least one first peak element;
performing Doppler processing on each distance chirp matrix to obtain a distance rate matrix, wherein each distance rate matrix comprises at least one second peak element;
performing first angle processing on each first peak element corresponding to a same position in the distance chirp matrices to obtain a first angle corresponding to each first peak element;
performing second angle processing on each second peak element corresponding to a same position in the distance rate matrices to obtain a second angle corresponding to each second peak element; and
obtaining a plurality of pieces of information corresponding to a target according to the first peak element and the second peak element respectively corresponding to the matched first angle and the matched second angle.

2. The radar signal processing method according to claim 1, wherein the step of obtaining a plurality of pieces of information corresponding to a target comprises:
separately obtaining the pieces of information according to each first peak element and each second peak element; and
classifying each piece of information corresponding to each of the matched first angle and the matched second angle into a group, to use pieces of information in a same group as the pieces of information of the target.

3. The radar signal processing method according to claim 1, wherein the step of obtaining a plurality of pieces of information corresponding to a target comprises:
classifying each first peak element and each second peak element respectively corresponding to the matched first angle and the matched second angle into a group; and
obtaining the pieces of information corresponding to the target according to each first peak element and each second peak element in a same group.

4. The radar signal processing method according to claim 1, wherein the target is an organism wearing a delayed reflection sensor.

5. The radar signal processing method according to claim 4, wherein the pieces of information comprise first information corresponding to the delayed reflection sensor and second information corresponding to the organism.

6. The radar signal processing method according to claim 5, wherein each first peak element and each second peak element respectively corresponding to the matched first angle and the matched second angle are classified into a group, wherein the step of obtaining a plurality of pieces of information corresponding to a target comprises:
separately converting a distance of each first peak element in a first part in a same group into delay time according to a linear frequency modulation slope of the frequency modulated continuous wave radar echo, wherein the first part is a part of the distance chirp matrix higher than a separation frequency point; and
calculating an identification code corresponding to the delayed reflection sensor according to the delay time corresponding to the same group, wherein the first information comprises the identification code.

7. The radar signal processing method according to claim 5, wherein each first peak element and each second peak element respectively corresponding to the matched first angle and the matched second angle are classified into a group, wherein the step of obtaining a plurality of pieces of information corresponding to a target comprises:
separately converting a distance of each first peak element in a first part in a same group into delay time according to a linear frequency modulation slope of the frequency modulated continuous wave radar echo, wherein the first part is a part of the distance chirp matrix higher than a separation frequency point; and
calculating sensing information corresponding to the delayed reflection sensor according to the delay time corresponding to the same group, wherein the first information comprises the sensing information.

8. The radar signal processing method according to claim 5, wherein each first peak element and each second peak element respectively corresponding to the matched first angle and the matched second angle are classified into a group, wherein the step of obtaining a plurality of pieces of information corresponding to a target comprises:
obtaining distance information of the target according to a distance of each first peak element in a second part in a same group, wherein the second part is a part of the distance chirp matrix lower than a separation frequency point, and the second information comprises the distance information.

9. The radar signal processing method according to claim 5, wherein each first peak element and each second peak element respectively corresponding to the matched first angle and the matched second angle are classified into a group, wherein the step of obtaining a plurality of pieces of information corresponding to a target comprises:
calculating at least one piece of physiological information corresponding to the organism according to a rate of each second peak element in a second part in a same group, wherein the second part is a part of the distance rate matrix lower than a separation frequency point, and the second information comprises the at least one piece of physiological information.

10. A radar signal processing method, performed by a radar detection device, the radar signal processing method comprising:
obtaining a plurality of channel signals corresponding to a frequency modulated continuous wave radar echo through the radar detection device, wherein each of the channel signals comprises a plurality of digital signals corresponding to a plurality of chirp echoes;
separately performing range processing on digital signals of a same ordinal in the channel signals, to obtain a distance channel matrix;
performing angle processing on each distance channel matrix to obtain a range-azimuth matrix, wherein each range-azimuth matrix comprises at least one peak element;
obtaining first information according to the at least one peak element in a first part of the range-azimuth matrices, wherein each piece of first information corresponds to a first angle of the corresponding peak element;
performing Doppler processing on each peak element corresponding to a same position in a second part of the range-azimuth matrices to obtain second information, wherein the second information corresponds to a second angle of the corresponding peak element; and
classifying the first information and the second information respectively corresponding to the matched first angle and the matched second angle into a group, to obtain a plurality of pieces of information corresponding to a target.

11. The radar signal processing method according to claim 10, wherein each peak element corresponds to a distance and an angle, wherein the angle of each peak element in the first part is the first angle, the angle of each peak element in the second part is the second angle, the first part is a part of the range-azimuth matrix higher than a separation frequency point, and the second part is a part of the range-azimuth matrix lower than the separation frequency point.

12. The radar signal processing method according to claim 11, wherein the target is an organism wearing a delayed reflection sensor, and the pieces of information comprise the first information corresponding to the delayed reflection sensor and the second information corresponding to the organism.

13. The radar signal processing method according to claim 12, wherein the step of obtaining first information comprises:
separately converting the distance of each peak element in the first part into delay time according to a linear frequency modulation slope of the frequency modulated continuous wave radar echo; and
calculating an identification code corresponding to the delayed reflection sensor according to the delay time corresponding to a same group, wherein the first information comprises the identification code.

14. The radar signal processing method according to claim 12, wherein the step of obtaining first information comprises:
separately converting the distance of each peak element in the first part into delay time according to a linear frequency modulation slope of the frequency modulated continuous wave radar echo; and
calculating sensing information corresponding to the delayed reflection sensor according to the delay time corresponding to the same group, wherein the first information comprises the sensing information.

15. The radar signal processing method according to claim 12, further comprising:
obtaining distance information of the target according to the distance of each peak element in the second part in a same group; and
classifying the distance information into the group corresponding to the matched angle, wherein the second information comprises the distance information.

16. The radar signal processing method according to claim 12, wherein the step of obtaining second information comprises:
performing Doppler processing on the peak element corresponding to a same position in the second part of the range-azimuth matrices to obtain a rate; and
calculating at least one piece of physiological information corresponding to the organism according to each rate in a same group, wherein the second information comprises the at least one piece of physiological information.

17. A radar detection device, comprising:
a radar unit, configured to collect and demodulate a frequency modulated continuous wave radar echo to obtain a plurality of channel signals; and
a processing unit, configured to:
perform range processing on the channel signals to obtain a matrix, wherein the matrix is divided into a first part and a second part according to a separation frequency point;
obtain first information and a corresponding first angle according to the first part;
obtain second information and a corresponding second angle according to the second part; and
obtain a plurality of pieces of information corresponding to a target according to the first information and the second information respectively corresponding to the matched first angle and the matched second angle.

18. The radar detection device according to claim 17, wherein the target is an organism wearing a delayed reflection sensor.

19. The radar detection device according to claim 18, wherein the pieces of information comprise the first information corresponding to the delayed reflection sensor and the second information corresponding to the organism.

20. The radar detection device according to claim 17, wherein the first angle and the second angle are obtained through angle processing, and the second information is obtained through Doppler processing.
